(19) United States
(12) Patent Application Publication
(10) Pub. No.: US 2012/0027502 A1
(43) Pub. Date: Feb. 2, 2012

(54) ROTATIONAL BINDER ASSEMBLY FOR PAGE IDENTIFICATION

(76) Inventors: Tao Xu, Naperville, IL (US); Rolando Cavazos, Bartlett, IL (US); Thomas Carsello, Bartlett, IL (US)

(21) Appl. No.: 13/263,062

(22) PCT Filed: Apr. 6, 2010
(86) PCT No.: PCT/IB10/00740

§ 371 Date: Oct. 5, 2011

Related U.S. Application Data
(60) Provisional application No. 61/211,910, filed on Apr. 6, 2009.

(51) Int. Cl. B42F 13/20

(52) U.S. Cl. 402/4

(57) ABSTRACT

The present invention relates to a page identification system, method and apparatus implemented with respect to a rotational binder assembly for a book. This rotational binder assembly retains the pages of the book on a plurality of rings whereby rotation of these rings actuate further components of the invention to identify the pages or sheets to which the book is opened. The invention incorporates an output or output system which can be utilized to provide a specific output to a user of the invention based on the page identified as opened for the book.

### FIELD OF THE INVENTION

The present invention relates to a page identification system, method and apparatus implemented with respect to a rotational binder assembly for a book. This rotational binder assembly retains the pages of the book on a plurality of rings whereby rotation of these rings actuate further components of the invention to identify the pages or sheets to which the book is opened. The invention incorporates an output or output system which can be utilized to provide a specific output to a user of the invention based on the page identified as opened for the book.

### BACKGROUND ART

Identifying to which page or spread of pages a book has been opened to is very useful information to know as it allows selective interaction with is the user of the book depending on the content of the particular page or pages which the book is open to. One application that is particularly popular with board books for children involves an audio and/or visual presentation being made to the user of the book while the book is being read. In such applications, the opening of the book to a particular page spread can trigger recorded pronunciation of the name of a displayed object, playback of prerecorded audio relayed to a reading of the text displayed on a particular page, playback of a recorded song or any other audio or visual effects associated with the content of the current pages to which the book is opened.

Various systems for identifying page spread and the open pages of a book have previously been developed, such as those detailed in the preamble of PCT Patent Publication WO2007/023361, in addition to the content of this PCT publication itself.

It would be of advantage to have an alternative system mechanism or apparatus available to the systems cited above to at least provide the public with a useful choice. It would also be desirable to provide a page identification system that ameliorates or overcomes one or more known disadvantages of existing techniques or that may provide a useful alternative to them.

### SUMMARY OF THE INVENTION

According to one aspect of the invention there is provided a rotational binder assembly for page identification, the binder being arranged to retain a plurality of sheets forming the pages of a book and to identify which page or pages the book is opened to, the binder assembly including:

a plurality of rings, each ring having a variable radius and being capable of independent rotation relative to the remaining rings, with at least one ring being provided for each sheet of the book;

each sheet being fixed to at least one ring with all other remaining sheets of the book being threaded over said at least one ring to allow free movement of said remaining sheets over said at least one ring;

a switch array adjacent to the plurality of rings, the switch array including a switch for each sheet retained by the binder assembly,

whereby rotation of a ring to or past a defined degree of rotation actuates at least one switch of the switch array,

wherein the combination of actuated switches of the switch array identifies the pages or pages which the book is opened to.

Preferably, a single ring of said rotational binder assembly is fixed to each sheet.

Preferably, a switch of the switch array includes a pair of moving contact plates, said contact plates being moveable towards each other and into contact with each other and away from each other out of contact from each other.

Preferably, the variable radius of a ring forms a cam which drives together or moves apart the contact plates of a switch. This variable radius of the ring which forms a cam will therefore be used to actuate a switch once the ring has moved through or past a defined degree of rotation, presenting the protruding sections of the ring in contact with the contact plate or plates of a switch.

Preferably, the switch array is integrated into an electronic systems unit.

Preferably, the electronic systems unit includes a power supply arranged to supply electrical current to each switch of the switch array.

Preferably, the electronic systems unit includes an output system. An output or output system integrated into the present invention may be used to provide, present or otherwise make available to a user further content to that already presented with respect to the sheets or pages of the book. For example, in one embodiment an output system may incorporate audio elements and associated memory devices where the identification of a specific opened page of the book will retrieve and play back a specific audio file related to the current content of the page. In other embodiments the output system may also incorporate display elements such as LCD screens which can present animated video content to a user of the invention. Those skilled in the art should appreciate that a wide range and variety of output or output systems may be integrated, within and used in conjunction with the present invention.

Preferably, the electronic systems unit includes a circuit board incorporating a processor wherein the circuit board connects the output system, processor and switch array. A processor may be formed by a compact relatively low cost microprocessor which can be programmed with embedded software or instructions to facilitate the operation of the output system depending on the page. Such a processor may readily be configured to actuate or operate a range of output systems as should be appreciated by those skilled in the art.

Reference in general throughout the specification will also be made to the electronic circuit board providing and including a processor connected to the output system and the switch array, where this processor is programmed to identify the page to which the book and binder is opened to based on the configuration of the switch array. However those skilled in the art should appreciate that in other embodiments a processor need not necessarily be provided for the invention to function effectively. For example, in some alternative embodiments discreet analogue electrical components may be used to implement control components of the electronic circuit board to both effectively identify the page to which the book and binder is opened and subsequently trigger the correct response from the output system.

Preferably, the processor assesses the combination of actuated switches of the switch array to identify the page or pages to which the book is opened.

Preferably, the processor triggers the operation of the output system based on the page or pages identified.

Preferably, the plurality of rings are removably attached to the electronic systems unit.

Preferably, a ring alignment rod arranged to locate each of the plurality of rings of the binder with the same axis of rotation.

This invention presents a rotational binder assembly that interacts with an array of switches connected to an electronic device to recognize each page or sheet of a book when it is turned for viewing.

The rotational binder assembly consists of or incorporates a series of independently rotatable rings. The rings can have by a common axis to make an aligned book binder.

Reference in general will be made throughout this specification to a sheet being fixed to or fixed in relation to a ring of the rotational binder assembly. In a further preferred embodiment the fixing of sheets relative to rings may be completed through a clamping arrangement whereby two adjacent surfaces of a ring are pushed into close engagement with opposites sides of a sheet to permanently fix the relative position of the sheet with respect to the rings.

However, in other embodiments fixing of sheets to rings may not necessarily be completed through clamping operations or clamping components. For example, in one alternative embodiment a ring may be trapped between two opened blocking or locking faces presented by a section of the ring, where these blocking faces have a larger surface area or diameter than any holes punched through the sheet to mount it on the ring. In this embodiment a sheet may have a degree of freedom of movement relative to a ring but still be trapped or fixed onto a ring by this pair of opposed blocking sections or faces.

Those skilled in the art should appreciate that a range of mechanisms may be employed to various embodiments to fix a sheet to a ring of the rotational binder. Reference in general however throughout the specification will now be made to a sheet being clapped to a ring, but those skilled in the art should appreciate this should in no way be seen limiting.

Each ring of the binder may only be permanently clamped onto one specific sheet in addition to going through all the holes of the rest of the sheets of the book. In this way, the ring will rotate when the page that it is clamped to turns, with the rings forming the actuators of the electronic device.

Each ring has a variable radius design which activates a switch of the switch array when a specific page turns to a predefined angle of rotation.

The ring is designed to achieve a number of functions on the rotational binder assembly. A first function can be to clamp onto one sheet so the ring is only permanently attached to one sheet. A second function can be to be the actuator of the switch array, activating a switch after a defined number of degrees of rotation of the ring. A third function of the ring can be to bind to the rest of the pages that are not clamped onto the ring and free to rotate “around” the ring. A fourth function can be to maintain a center axis of rotation aligned with the rest of rings that are part of the rotational binder assembly.

The center of each ring may have a cylinder where a rod is inserted. This ring alignment rod can keep the rings aligned in the same axis of rotation.

The binding of the sheets is an important feature of the present invention. Each ring may be permanently attached to one sheet only; the other sheets may preferably be moved freely using inner diameter of the ring as a guide.

For example, if a book has 5 sheets, then each sheet needs to have at least 5 holes, in order to have each page identified. At least one of these holes will be smaller on each page, to form a clamping hole, and the location of this clamping hole will be different on each sheet. The rest of the holes, the free holes, will be large enough so that the other 4 sheets that are not permanently attached can rotate freely around the axis of rotation of the ring. If we want to attach the first sheet, which could be the cover sheet, to the first ring, which could be on top of the binder assembly, then the top hole. on the first sheet will be the clamping hole, which is smaller than the rest of the holes so that the ring can be permanently attached to the first sheet on the top hole.

However, those skilled in the art should appreciate that other implementations or embodiments of the invention may not necessarily provide a single ring clamped to a single sheet or page of the book. For example, in some alternative embodiments a degree of redundancy may be used in the provision of the rings, with two or more rings being clamped to a single sheet of the book. These two or more rings may effectively be redundant with respect to one another, with each ring being clamped to the single sheet only.

Reference in general throughout the specification will however be made to a single ring being clamped to a single sheet, however those skilled in the art should appreciate that such redundant implementations of rings may also be used if required.

To have the rings activate the switch array in a consistent and reliable way, the axis of rotation of the binder needs to be stationary relative to the switch array. This can be achieved by placing the center “shaft” of the binder assembly into two or more permanent or “break-away” retainers on a book holder which the switch array is affixed to. These retainers can therefore restrict the lateral motion of the binder while allowing the free rotation of the binder along its axis of rotation.

The rotational binder assembly can be represented in two configurations, integrated and detachable.

For example, in such embodiments the rotational binder may have a detachable form, allowing the electronic system to be used with a range of different ring and sheet combination. In such embodiments the electronic system may be adapted to receive a fixed number or set of rings and associated sheets of a book—potentially while also receiving replacement or updated media content to be provided in relation to the output system. With this detachable configuration the electronic system may be reused or recycled to service a large number and range of different ring assemblies and associated books.

In a preferred embodiment, the rings of the rotational binder assembly may be formed from plastic material. Plastic material is relatively inexpensive to produce and also has insulative qualities, thereby preventing any faults present in the ring's structure from interfering with the operation of the switch use.

In this specification, unless the context clearly indicates otherwise, the term “comprising” has the non-exclusive meaning of the word, in the sense of “including at least” rather than the exclusive meaning in the sense of “consisting only of”. The same applies with corresponding grammatical changes to other forms of the word such as “comprise”, “comprises” and so on.

### BRIEF DESCRIPTION OF THE DRAWINGS

A preferred embodiment of the invention will now be described by way of example only, with reference to the accompanying figures in which:

FIG. 1 shows an isometric view of a rotational binder assembly provided in accordance with a preferred embodiment detached from the electronics system unit. This assembly includes five rings and five sheets; the first sheet is shown rotated (open).

FIG. 2 shows an isometric view of the rotational binder assembly of FIG. 1 attached to the electronics system unit. This figure shows a diagram of a simplistic electronic system that includes a switch array, a power source, an electronics circuit board and an output

FIG. 3 shows the location of the section view J-J in the rotational binder assembly of FIGS. 1 and 2 attached to the electronics system unit

FIG. 4 shows an isometric view of the section view J-J of FIG. 3. The section view demonstrates the ring 6 activating the switch array with the activation cam. It demonstrates the axis of rotation, the free holes (not clamped), and the clamping feature. It also demonstrates a simple activation of the switch between contacts.

FIG. 5 shows a top view of second sheet of rotational binder assembly of FIGS. 1-4. The second sheet is clamped to the second hole (from top to bottom). Clamping hole is smaller than the rest of the holes on the same sheet

FIG. 6 shows a top view of the rotational binder assembly of FIGS. 1-5 attached to the electronics system unit. It demonstrates the location of section K-K and section L-L

FIG. 7 shows section K-K, it demonstrates a cross section of third ring clamped to the third page. The ring is the actuator of the third switch of the switch array

FIG. 8 shows section L-L, it demonstrates a cross section of fifth ring clamped to the fifth page. The ring is not actuating the fifth switch of the switch array. The switch is shown in the closed position

FIGS. 9A, 9B show plan and underside perspective views of a ring employed in accordance with an alternative embodiment of the present invention which does not clamp a sheet or page between two immediately adjacent sections of the ring.

### BEST MODES FOR CARRYING OUT THE INVENTION

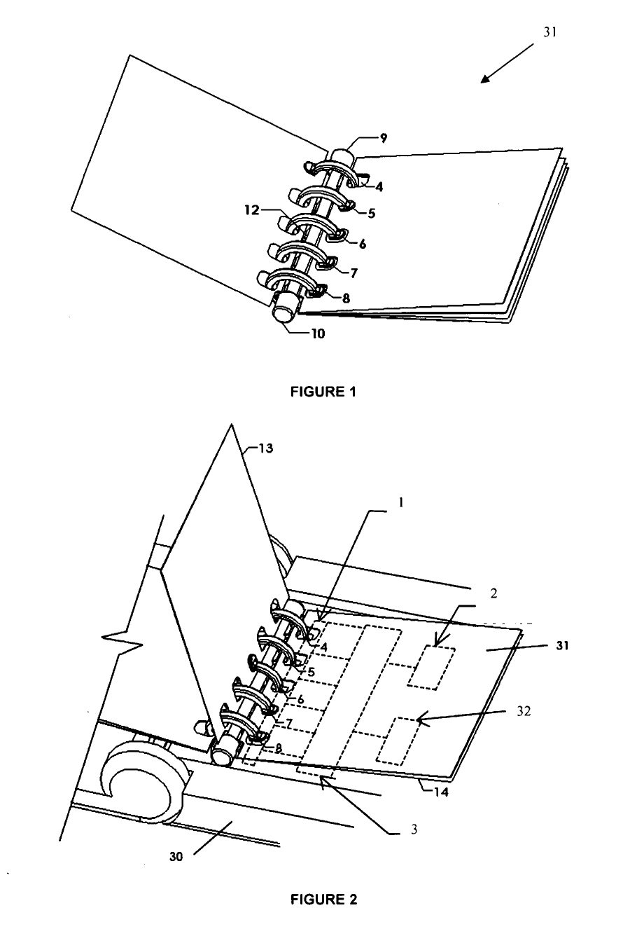

FIGS. 1-8 illustrate a rotational binder assembly as provided in accordance with a preferred embodiment

The invention illustrated is directed to a page identification device integrated by a rotational binder assembly (31) with independent actuators rings that interact with an array of switches (1) located in a unit that has an electronic system. This interaction permits the sheet or page identification. The electronic system includes a power source (2), an electronics circuit board (3), the switch array (1) and an output or output system (32). This output system (32) can have different representations or implementations depending on the application of the present invention; some examples include sound/audio emission, light emission, or any type of electronic display. The output system is programmed to provide specific output based on the interaction between the actuation of the pages and the array of switches.

FIG. 1 shows the rotational binder assembly unattached from the electronics unit. The binder is integrated by 5 sheets and 5 rings, each ring is permanently attached to only one sheet. The clamping feature of the rings are located on one side of the rings 4, 5, 6, 7 & 8. All rings have the same axis 12 of rotation. The book is also showing retainer caps 9 & 10, which help to keep the rings in place. These retainer caps can also be used to hold the rotational binder assembly to the electronics unit.

In the embodiment shown the binder has a detachable configuration. The detachable configuration consists of a rotational binder assembly that is detachable from the unit that holds the switches and the electronic system. In an alternative embodiment an integrated configuration consists of a rotational binder assembly book permanently attached to the unit that holds the switch array and the electronic system.

FIG. 2 shows the rotational binder assembly 31 attached to the electronics system or unit 30. The electronic system consists of a power source, an electronics circuit board, the switch array and the output. The output can have different representations depending on the application of the present invention; some examples include sound/audio, light, or any type of electronic display. The output can be programmed or pre-recorded to interact with the array of switches.

Each switch is essentially a binary device: it is either completely closed or completely open. The simplest type of switch is one where two electrical conductors are either in contact or separation with each other by the motion of an actuating mechanism, which is the ring of the rotational binder assembly.

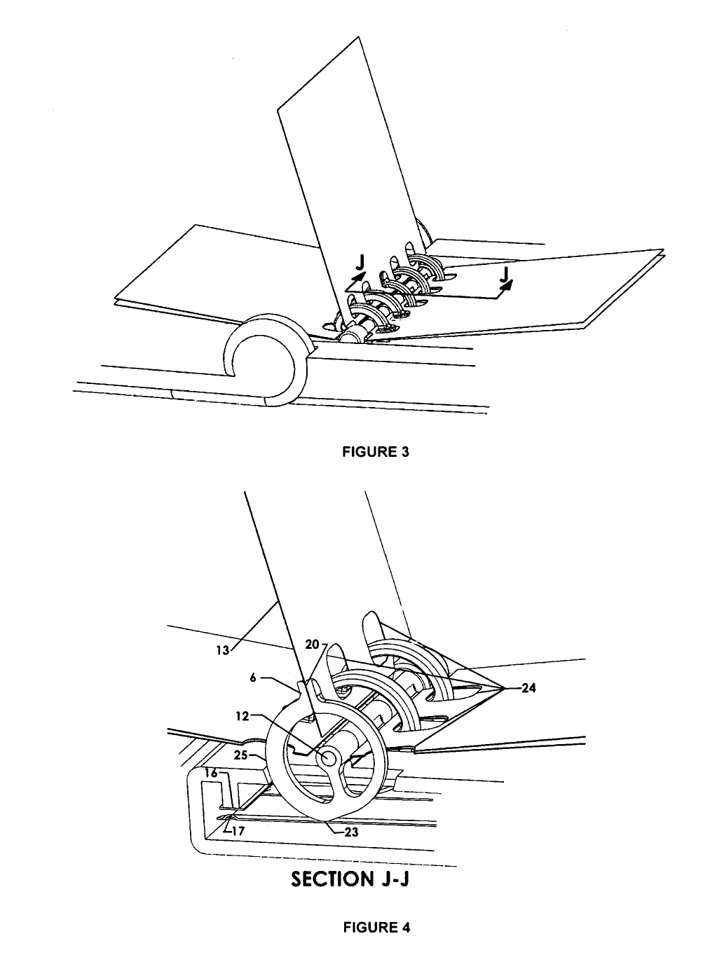

FIG. 3 shows the location of the section view J-J. FIG. 4 shows the cross section in a perspective view of the third page 13 rotated a certain number of degrees. The third page 13 is permanently attached to the third ring 6 with the clamping feature 20. This section view also illustrates how the rings that are not attached to the third page 13 have bigger holes 24 that allow the other pages to rotate around the non attached rings.

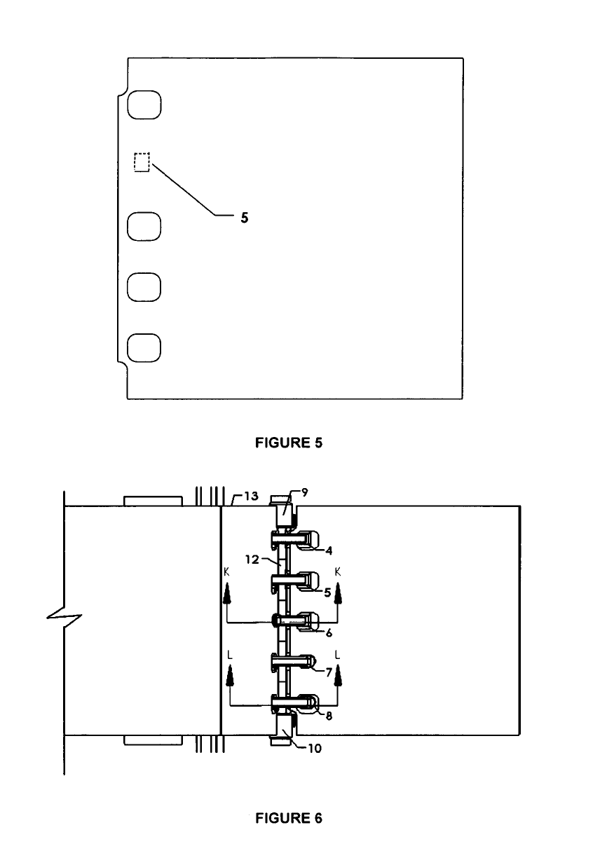

When one page is turning only one ring is being rotated around the axis of rotation, the other holes on the page are freely moving around the other rings. If we take the second page of the book for example, we can see that the second hole is smaller to allow ring 5 to clamp onto the sheet, this is illustrated in FIG. 5.

FIG. 6 shows a top view of the rotational binder assembly attached to the electronics unit. The third page 13 is rotated a certain number of degrees. It shows the location of section view K-K & L-L.

To illustrate how the ring design acts as an actuator of the switch array, section view K-K is a cross section of a ring in contact with the a switch incorporating by contact plates 16 & 17. For the illustration of the present innovation, the contact plates are shown in contact when the ring is not touching the switch. Once the ring starts touching the switch then a separation starts between the contact plates. The section view L-L is a cross section of a ring in no contact with the switch.

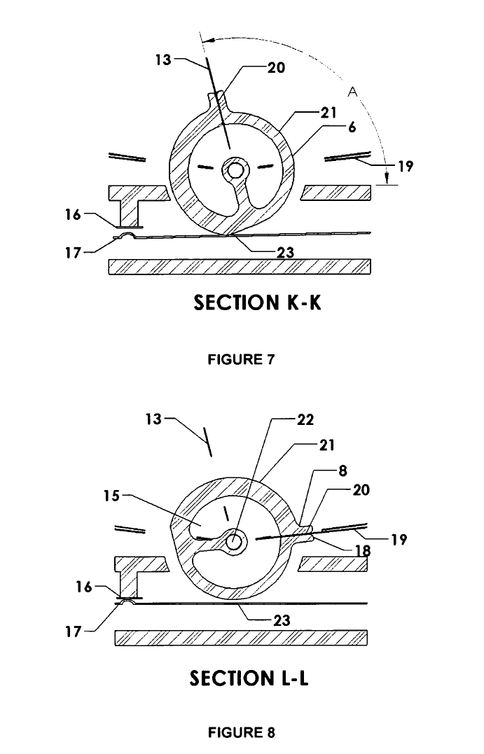

FIG. 7 shows the section view K-K turning the third sheet 13. After a certain number of degrees of rotation A, the ring starts separating the contact plates 16 & 17 of the switch; this changes the status of the switch array which is connected to the electronics circuit board, as shown in FIG. 2.

FIG. 8 shows the section view L-L, illustrating how the contact plates are in contact when the ring is not actuating the switch.

The electronics circuit board identifies which conductor contact plates are in contact and which ones are separated depending on how many sheets or pages are turned. This combination of the switch array is processed to a provide specific output, submitting a different output every time the combination on the switch array changes.

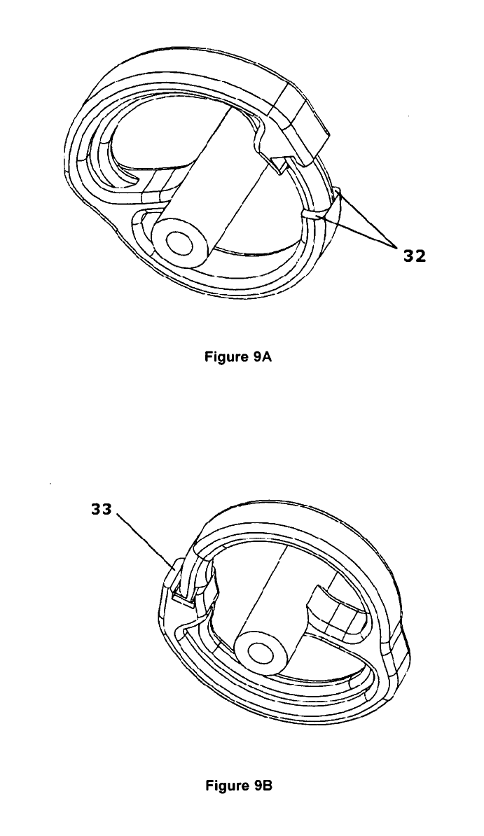

FIGS. 9A, 9B show plan and underside perspective views of a ring employed in accordance with an alternative embodiment of the present invention which does not clamp a sheet or page between two immediately adjacent sections of the ring.

These figures show two displaced blocking faces 32, 33 disposed on one section of the perimeter of the ring. As can be seen from these figures the region or the section of the perimeter of the ring between these two blocking faces can still trap a sheet while also allowing a small degree of relative movement of the sheet to the ring. In such a way this form of ring can fix a sheet relative to itself while not necessarily clamping the sheet to the ring.

It will be apparent that obvious variations or modifications may be made which are in accordance with the spirit of the invention and which are intended to be part of the invention, and any such obvious variations or modifications are therefore within the scope of the invention.

Although the invention is described above with reference to specific embodiments, it will be appreciated by those skilled in the art that it is not limited to those embodiments, but may be embodied in many other forms.

1. A rotational binder assembly for page identification the binder being arranged to retain a plurality of sheets forming the pages of a book and to identify which page or pages the book is opened to, the binder assembly including:
a plurality of rings, each ring having a variable radius and being capable of independent rotation relative to the remaining rings, with at least one ring being provided for each sheet of the book;
each sheet being fixed to at least one ring with all other remaining sheets of the book being threaded over said at least one ring to allow free movement of said remaining sheets over said at least one ring;
a switch array adjacent to the plurality of rings, the switch array including a switch for each sheet retained by the binder assembly,
whereby rotation of a ring to or past a defined degree of rotation actuates at least one switch of the switch array,
wherein the combination of actuated switches of the switch array identifies the pages or pages which the book is opened to.

2. A rotational binder assembly as claimed in claim 1, wherein a single ring is fixed to each sheet.

3. A rotational binder assembly as claimed in claim 1, wherein a switch of the switch array includes a pair of moving contact plates, said contact plates being moveable towards each other and into contact with each other and away from each other out of contact from each other.

4. A rotational binder assembly as claimed in claim 3, wherein the variable radius of a ring forms a cam which drives together or moves apart the contact plates of a switch.

5. A rotational binder assembly as claimed in claim 1, wherein the switch array is integrated into an electronic systems unit.

6. A rotational binder assembly as claimed in claim 5, wherein the electronic systems unit includes a power supply arranged to supply electrical current to each switch of the switch array.

7. A rotational binder assembly as claimed in claim 5, wherein the electronic systems unit includes an output system.

8. A rotational binder assembly as claimed in claim 7, wherein the electronic systems unit includes a circuit board incorporating a processor wherein the circuit board connects the output system, processor and switch array.

9. A rotational binder assembly as claimed in claim 8, wherein the processor assesses the combination of actuated switches of the switch array to identify the page or pages to which the book is opened.

10. A rotational binder assembly as claimed in claim 9, wherein the processor triggers the operation of the output system based on the page or pages identified.

11. A rotational binder assembly as claimed in claim 5, wherein the plurality of rings are removably attached to the electronic systems unit.

12. A rotational binder assembly as claimed in claim 1 which includes a ring alignment rod arranged to locate each of the plurality of rings of the binder with the same axis of rotation.
